(19) United States
(12) Patent Application Publication
(10) Pub. No.: US 2011/0022823 A1
(43) Pub. Date: Jan. 27, 2011

(54) INFORMATION PROCESSING SYSTEM AND INFORMATION PROCESSING METHOD THEREOF

(75) Inventor: Hideyuki MIWA, Kanagawa (JP)

Correspondence Address: FOLEY AND LARDNER LLP;SUITE 500, 3000 K STREET NW, WASHINGTON, DC, 20007, US

(73) Assignee: NEC Electronics Corporation

(21) Appl. No.: 12/795,251

(22) Filed: Jun. 7, 2010

(30) Foreign Application Priority Data
Jul. 27, 2009 (JP) 2009-174187

(51) Int. Cl. G06F 9/302; G06F 9/30

(52) U.S. Cl. 712/208; 712/221; 712/E09.016; 712/E09.017

(57) ABSTRACT

An information processing system includes an execution unit and a decoder. The execution unit includes a plurality of arithmetic units each having a first operation circuit that performs a first operation on a first input value and a second input value, a second operation circuit that performs a second operation on the first input value and the second input value, and a selector that selects and outputs either a first output value output from the first operation circuit or a second output value output from the second operation circuit based on a selection signal. The decoder decodes an operation instruction and determines each value of the selection signal of each arithmetic unit. The decoder determines the value of the selection signal corresponding to the operation instruction with respect to each program.

### INCORPORATION BY REFERENCE

This application is based upon and claims the benefit of priority from Japanese patent application No. 2009-174187, filed on Jul. 27, 2009, the disclosure of which is incorporated herein in its entirety by reference.

### BACKGROUND

1. Field of the Invention

The present invention relates to an information processing system, and more particularly, to an information processing system and an information processing method thereof that include a SIMD (Single Instruction Multiple Data) arithmetic unit which switches a combination of arithmetic operations performed in parallel in accordance with an operation instructions.

2. Description of Related Art

In recent years, an information processing system such as a processor implements a SIMD arithmetic unit that performs an arithmetic operation with a SIMD arithmetic method so as to improve an arithmetic performance per clock cycle. The SIMD arithmetic unit includes a plurality of arithmetic units. Each of the arithmetic units includes a first operation circuit that performs a first operation (e.g., addition), a second operation circuit that performs a second operation (e.g., subtraction), and a selector that selects and outputs either a first output value output from the first operation circuit or a second output value output from the second operation circuit based on a selection signal.

The SIMD arithmetic unit, for example, has m arithmetic units. If a data width of one data that is processed in one clock cycle is a-bit, each of the arithmetic units processes the data that has data width of a/m-bit. At this time, the SIMD arithmetic unit can select either the first output value or the second output value with respect to each arithmetic unit. That is, it is possible for the SIMD arithmetic unit to perform independent arithmetic operations with respect to each arithmetic unit.

Japanese Unexamined Patent Application Publication No. 2003-241960 and “Texas Instruments, Inc., TMS320C64x/C64x+ DSP CPU and Instruction Set Reference Guide, Literature Number SPRU732C, August 2006” disclose an example of the SIMD arithmetic unit described above. The processor disclosed in Japanese Unexamined Patent Application Publication No. 2003-241960 is improved with performance in the actual data processing by extending an operation instruction that is provided to the SIMD arithmetic unit. More specifically, in Japanese Unexamined Patent Application Publication No. 2003-241960, the operation instruction that improves flexibility of an output bit field is added to an existing operation instruction.

Further, in “Texas Instruments, Inc., TMS320C64x/C64x+ DSP CPU and Instruction Set Reference Guide, Literature Number SPRU732C, August 2006”, an operation code (which is included in an operation instruction) for determining a combination of arithmetic operations in a SIMD arithmetic unit is preliminarily determined. The operation instruction that includes the determined operation code is provided to the SIMD arithmetic unit.

### SUMMARY

The present inventor has found problems as described below. A data width of the operation instruction provided to the SIMD arithmetic unit is determined in accordance with specifications of hardware. Further, in addition to the operation code that determines the combination of arithmetic operations in a SIMD arithmetic unit, the operation instruction includes a register address that indicates input and output address of the arithmetic operation data. That is, a data width of the bit field permitted for the operation code is restricted. Therefore, in the SIMD arithmetic unit, the combinations of arithmetic operations that are used within a number of the arithmetic operations expressed with the permitted data width are preliminarily determined. In Japanese Unexamined Patent Application Publication No. 2003-241960 and “Texas Instruments, Inc., TMS320C64x/C64x+ DSP CPU and Instruction Set Reference Guide, Literature Number SPRU732C, August 2006”, the number of the operation code is also preliminarily determined.

However, if a program that is executed in the information processing system that includes the SIMD arithmetic unit uses a combination other than the combination that is preliminarily determined by the operation code, the SIMD arithmetic unit according to the related art cannot accommodate the change of the combination of the arithmetic operations specified by the operation code. This is because, in the SIMD arithmetic unit according to the related art, the combination of the arithmetic operations specified by the operation code is determined at a design-time of the hardware, and it is impossible to change the combination after the design-time of the hardware. Further, even if trying to prepare for the operation code that corresponds to the combination of all operations to improve the degree of freedom of the combination of the arithmetic operations that are performed by software, it is impossible to prepare the operation code that corresponds to all combinations of the arithmetic operations because of the restriction of the data width permitted for the operation code as mention above.

A first exemplary aspect of the present invention is an information processing system that executes an information processing corresponding to a program including: an execution unit that includes a plurality of arithmetic units each having a first operation circuit that performs a first operation on a first input value and a second input value, a second operation circuit that performs a second operation on the first input value and the second input value, and a selector that selects and outputs either a first output value output from the first operation circuit or a second output value output from the second operation circuit based on a selection signal; and an decoder that decodes an operation instruction and determines each value of the selection signal of each arithmetic unit. The decoder determines the value of the selection signal corresponding to the operation instruction with respect to each program.

A second exemplary aspect of the present invention is An information processing system including: an operation code table register that stores values each corresponding to respective operation code; a decoder that is coupled to the operation code table register to output an select signal in accordance with the values that is stored in the operation code table register; an execution unit that includes a first operation circuit configured to perform a first operation based on a first value and a second value, a second operation circuit configured to perform a second operation based on the first value and the second value, and a selector that is coupled to the first and second operation circuits to select one of results of the first operation and the second operation in accordance with the select signal; and a load-store unit that is coupled to the operation code table register to change the values to another values in accordance with an operation to be executed by the information processing system.

A third exemplary aspect of the present invention is an information processing method for use in an information processing system that includes a plurality of arithmetic units each having a first operation circuit that performs a first operation on a first input value and a second input value, a second operation circuit that performs a second operation on the first input value and the second input value, and a selector that selects and outputs either a first output value output from the first operation circuit or a second output value output from the second operation circuit based on a selection signal, and executes an information processing corresponding to a program, the method including: determining a value of the selection signal corresponding to an operation instruction in accordance with the program; decoding the operation instruction in accordance with the determination and generating the select signal; and determining the output value that is output from the selector in the plurality of arithmetic units based on the value of the selection signal.

According to the information processing system and information processing method of the present invention, it is possible to arbitrarily determine the combination of the values of the selection signal corresponding to the operation instruction (or the combination of the arithmetic operations performed by the plurality of arithmetic units) with the program executed in the information processing system. That is, even though the data width permitted for the operation code is restricted, it is possible to combine the values of the selection signal that is necessary for the program within the restricted data width.

According to the information processing system and the information processing method of the present invention, it is possible to improve the degree of freedom of the combination of the arithmetic operations performed by the SIMD arithmetic unit within the limited number of the operation code.

### BRIEF DESCRIPTION OF THE DRAWINGS

The above and other exemplary aspects, advantages and features will be more apparent from the following description of certain exemplary embodiments taken in conjunction with the accompanying drawings, in which:

FIG. 1 is a block diagram showing an information processing system according to a first exemplary embodiment of the present invention;

FIG. 2 is a block diagram showing an execution unit according to the first exemplary embodiment of the present invention;

FIG. 3 is a diagram showing a data structure of an operation instruction for use in the information processing system according to the first exemplary embodiment of the present invention;

FIG. 4 is a block diagram showing an operation code decode unit including an operation code table register and an operation code decoder according to the first exemplary embodiment of the present invention;

FIG. 5 is a circuit diagram showing a code setting value register according to the first exemplary embodiment of the present invention;

FIG. 6 is a diagram showing an initial state of an operation code table according to the first exemplary embodiment of the present invention;

FIG. 7 is a diagram showing a state of an operation code table corresponding to a first program;

FIG. 8 is a diagram showing a state of an operation code table corresponding to a second program; and

FIG. 9 is an exemplary timing chart of a data processing of the information processing system according to the first exemplary embodiment of the present invention.

### DETAILED DESCRIPTION OF THE EXEMPLARY EMBODIMENTS

### First Exemplary Embodiment

Exemplary embodiment of the present invention will be described below with reference to the accompanying drawings. The present invention relates to an information processing system that includes a SIMD (Single Instruction Multiple Data) arithmetic unit. Hereinafter, a microcomputer is explained for the example of the information processing system. The microcomputer explained in this exemplary embodiment has the SIMD arithmetic unit separated from a main arithmetic unit. However, the SIMD arithmetic unit may be included in the main arithmetic unit. Further, the SIMD arithmetic unit may be implemented on the other semiconductor substrate on which the main arithmetic unit is implemented. That is, the implementation of the SIMD arithmetic unit is not limited in the present invention. Further, the information processing system reads out a program stored in a storage device implemented separately from the whole system and executes it. Moreover, in the information processing system according to this exemplary embodiment, the program is mainly executed at the main arithmetic unit, and some of the arithmetic operations of the program are performed by the SIMD arithmetic unit.

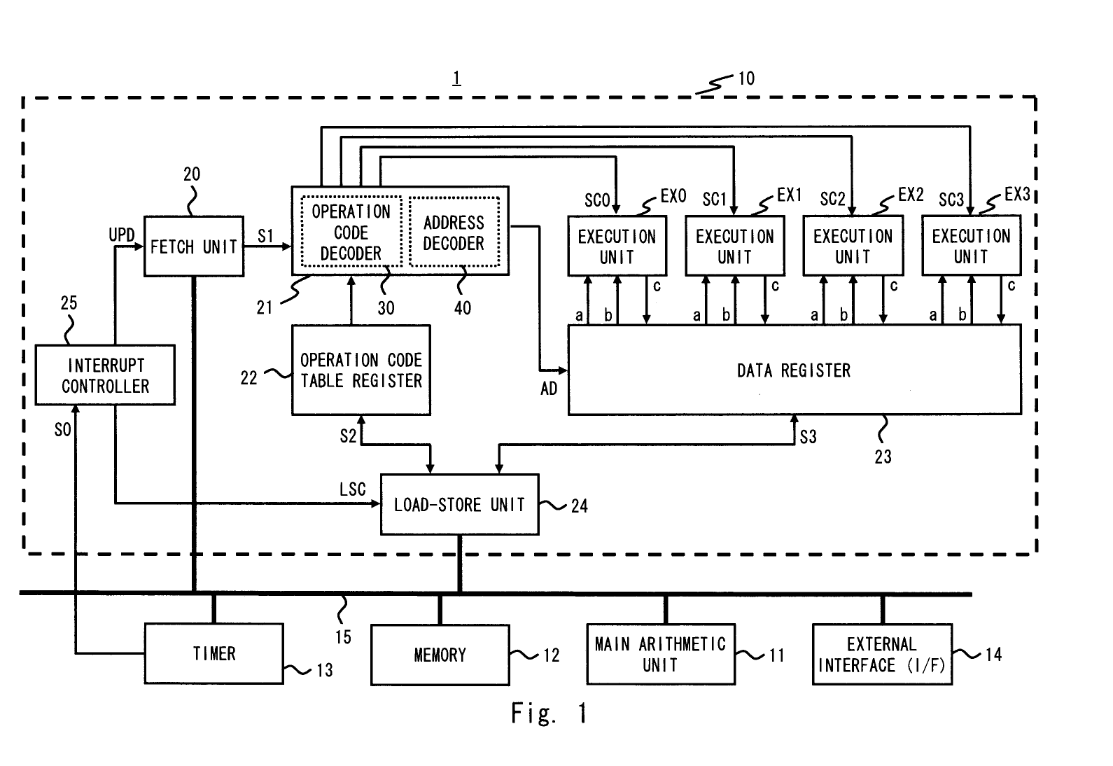

FIG. 1 is a block diagram showing an information processing system according to a first exemplary embodiment of the present invention. As shown in FIG. 1, the information processing system 1 includes a SIMD arithmetic unit 10, a main arithmetic unit 11, a memory 12, a timer 13, an external interface (I/F) 14, and a system bus 15. The SIMD arithmetic unit 10, the main arithmetic unit 11, the memory 12, the timer 13, and the external interface 14 are connected each other through the system bus 15.

The main arithmetic unit 11 reads out and executes the program stored in the storage device implemented outside or the memory 12. Further, when executing the program, the main arithmetic unit 11 outputs an instruction for performing the arithmetic operation of a part of the program to the SIMD arithmetic unit 10.

The memory 12 operates as a storage space of an intermediate data that is generated during a period of executing the program. Further, the memory 12 operates as the primary storage device. The timer 13 times an execute time of one program of the information processing system 1. Further, when the execute time reaches to a specified value, the timer 13 outputs an interrupt notification signal S0. In this exemplary embodiment, the timer 13 times the execute time of the program and directs a decoder 21 in the SIMD arithmetic unit 10 to switch values of a selection signal corresponding to an operation instruction with the use of the interrupt notification signal S0. The external interface 14 is an input-output interface between the information processing system 1 and various external equipments.

The SIMD arithmetic unit 10 is an arithmetic unit for performing a SIMD arithmetic operation. The SIMD arithmetic unit 10 includes a fetch unit 20, a decoder 21, an operation code table register 22, a data register 23, a load-store unit 24, an interrupt controller 25, and execution units EX0 to EX3. The SIMD arithmetic unit 10 is one of the characteristics of the present invention. Therefore, the configuration of the SIMD arithmetic unit 10 is described in detail below.

The execution units EX0 to EX3 include a plurality of arithmetic units, respectively. Note that each of the execution units EX0 to EX3 includes the arithmetic units each of which has the combination of different operations. The combinations of the operations performed by the execution units EX0 to EX3 can be set as desired in accordance with specifications. The execution unit EX0 is described in detail as an example for the execution units in this exemplary embodiment.

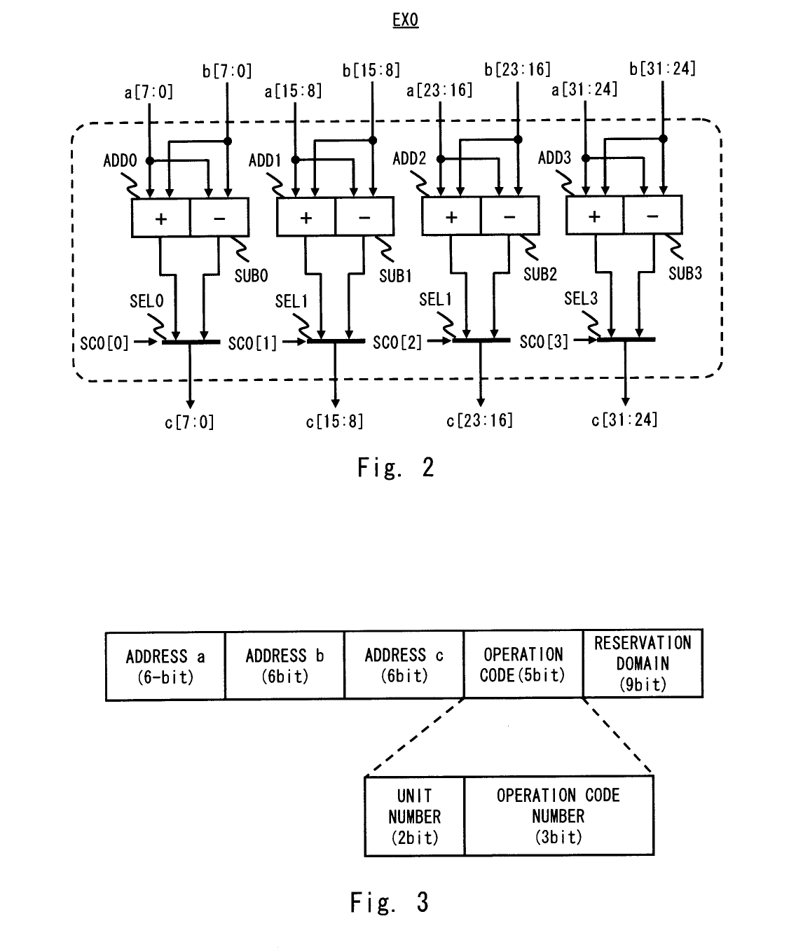

FIG. 2 is a detailed block diagram showing the execution unit EX0. As shown in FIG. 2, the execution unit EX0 includes first to fourth arithmetic units. The first to fourth arithmetic units have the same configuration. Each of the first to fourth arithmetic units includes a first operation circuit (e.g., adder ADD), a second operation circuit (e.g., subtractor SUB), and a selector SEL. Note that numbers that indicate the number of the arithmetic units are added after the symbol of ADD, SUB, and SEL. The adder ADD performs a first operation (e.g., addition) on a first input value stored at an address a of the data register 23 and a second input value stored at an address b of the data register 23, and outputs the result of the addition as a first output value. The subtractor SUB performs a second operation (e.g., subtraction) on the first input value stored at the address a of the data register 23 and the second input value stored at the address b of the data register 23, and outputs the result of the subtraction as a second output value. The selector selects either the first output value or the second output value based on the selection signal SC0 and outputs the selected output value as an output value. The output value is stored at an address c of the data register 23. Note that the selector outputs the result of the addition if the value of the selection signal SC0 is 0, and the selector outputs the result of the subtraction if the value of the selection signal SC0 is 1.

In the example shown in FIG. 2, a data width of the selection signal SC0 is 4-bit. The first bit value SC0[0] of the selection signal SC0 is input to the selector SEL0 of the first arithmetic unit. The second bit value SC0[1] of the selection signal SC0 is input to the selector SEL1 of the second arithmetic unit. The third bit value SC0[2] of the selection signal SC0 is input to the selector SEL2 of the third arithmetic unit. The fourth bit value SC0[3] of the selection signal SC0 is input to the selector SEL3 of the fourth arithmetic unit.

The execution unit EX0 inputs and outputs the data that has data width of 32-bit. The first arithmetic unit corresponds to a data processing for zeroth to seventh bits of the data. The second arithmetic unit corresponds to a data processing for eighth to fifteenth bits of the data. The third arithmetic unit corresponds to a data processing for sixteenth to twenty-third bits of the data. The fourth arithmetic unit corresponds to a data processing for twenty-fourth to thirty-first bits of the data.

In the execution unit EX0, the combination of the results of the addition and the subtraction is determined as an operation result of the first to fourth arithmetic units based on the selection signal SC0. That is, the input values are divided in quarters and each of the divided values is used for either the addition or the subtraction in the execution unit EX0.

The fetch unit 20 reads out the operation instruction from the memory 12 and outputs the operation instruction S1 to the decoder 21.

Further, the fetch unit 20 switches instruction streams which are read out based on an update signal UPD. The update signal UPD is output from the interrupt controller 25. Hereinafter, a data structure of the operation instruction in this exemplary embodiment is described. FIG. 3 is a diagram showing the data structure of the operation instruction in this exemplary embodiment. In the example shown in FIG. 3, a data width of the operation instruction S1 is 32-bit. The operation instruction S1 includes three addressing domains each of which has data width of 6-bit, an operation code domain that has data width of 5-bit, and a reservation domain that has data width of 9-bit. The addressing domains include a domain for specifying the address a of the data register 23 at which the first input value that is processed in the execution units EX0 to EX3 is stored, a domain for specifying the address b of the data register 23 at which the second input value that is processed in the execution units EX0 to EX3 is stored, and a domain for specifying the address c of the data register 23 at which the output values that are output from the execution units EX0 to EX3 as processing results are stored. The operation code domain includes a unit number domain and an operation code number domain. The unit number domain indicates the execution unit which actually performs the arithmetic operation. The operation code number domain specifies the combination of the arithmetic operations of a plurality of arithmetic units that are included in the specified execution unit. The reservation domain, for example, indicates a domain that stores instructions for the processing in the information processing system.

The decoder 21 decodes the operation instruction S1 that is provided from the fetch unit 20 and outputs an addressing signal AD and selection signals SC0 to SC3. Note that the selection signals SC0 to SC3 output from the decoder 21 correspond to the execution units EX0 to EX3, respectively. Further, one of the selection signals SC0 to SC3 becomes effective in accordance with the unit number of the operation code. Moreover, each of the selection signals SC0 to SC3 has a data width corresponding to the number of the arithmetic units that are included in one execution unit. Note that each of the selection signals SC0 to SC3 has data width of 4-bit in this exemplary embodiment.

The decoder 21 includes an operation code decoder 30 and an address decoder 40. The operation code decoder 30 decodes the operation code included in the operation instruction and outputs the selection signals SC0 to SC3. The address decoder 40 decodes a part of the address included in the operation instruction and outputs addressing signal AD.

The operation code table register 22 is a register that stores an operation code table defining the operation code and the value of the selection signal corresponding to the operation code. Hereinafter, the operation code table register 22 and the operation code decoder 30 are described in detail.

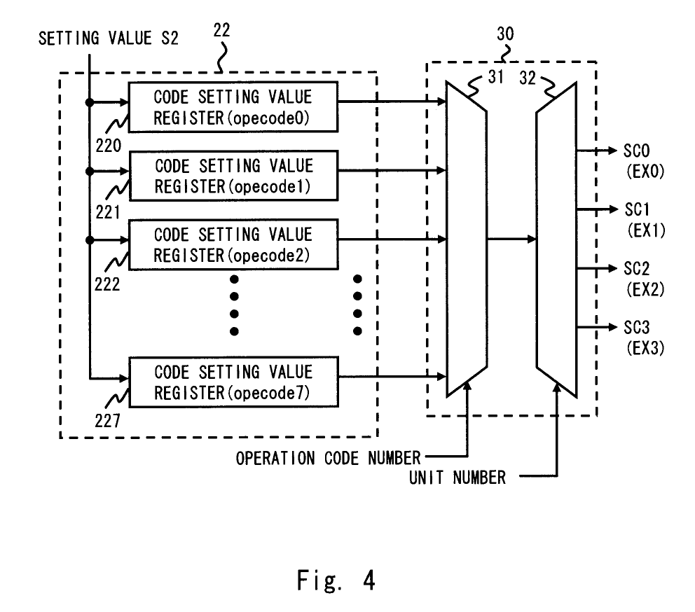

FIG. 4 is an exemplary block diagram showing the operation code table register 22 and the operation code decoder 30. As shown in FIG. 4, the operation code table register 22 includes code setting value registers 220 to 227 corresponding to the operation code numbers. Each of the code setting value registers stores values, the number of which is determined according to the number of the arithmetic unit included in the execution unit EX0 to EX3. Each of the code setting value registers stores four values in this exemplary embodiment. The values stored in the code setting value registers are setting values S2 provided from memory 12 through the load-store unit 24.

The operation code decoder 30 includes a multiplexer 31 and demultiplexer 32. The multiplexer 31 receives the output from the code setting value registers 220 to 227. Further, the multiplexer 31 selects and outputs the values of the code setting value register corresponding to the operation code number. The demultiplexer 32 output the setting values output from the multiplexer 31 to the execution unit corresponding to the unit number. The values output from the demultiplexer 32 come to the selection signal. The setting values included in the selection signal come to the values of the selection signal.

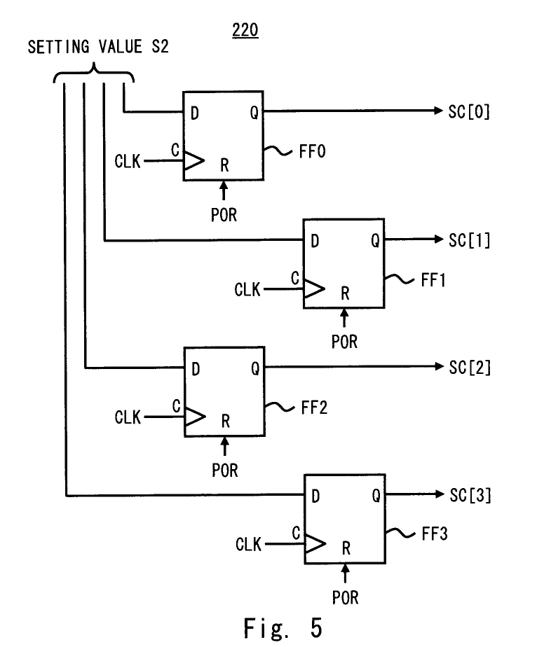

FIG. 5 is an exemplary block diagram showing the code setting value register. As shown in FIG. 5, the code setting value register includes flip-flop circuits. The number of the flip-flop circuits is determined in accordance with the number of the values stored in the code setting value register. In the example shown in FIG. 5, the code setting value register includes the flip-flop circuits FF0 to FF3. The setting values S2 are provided to each of the flip-flop circuits FF0 to FF3. For example, the flip-flop circuits FF0 to FF3 store and output the setting values S2 provided in accordance with a clock signal CLK supplied to the SIMD arithmetic unit 10. Further, a power-on reset signal POR is provided to the flip-flop circuits FF0 to FF3. The flip-flop circuits FF0 to FF3 come to the reset state (e.g., the state where the outputs of the flip-flop circuits FF0 to FF3 are 0) in accordance with the power-on reset signal POR. Note that the outputs of the flip-flop circuits FF0 to FF3 come to values of the selection signals SC[0] to SC[3] that correspond to the zeroth to third arithmetic units.

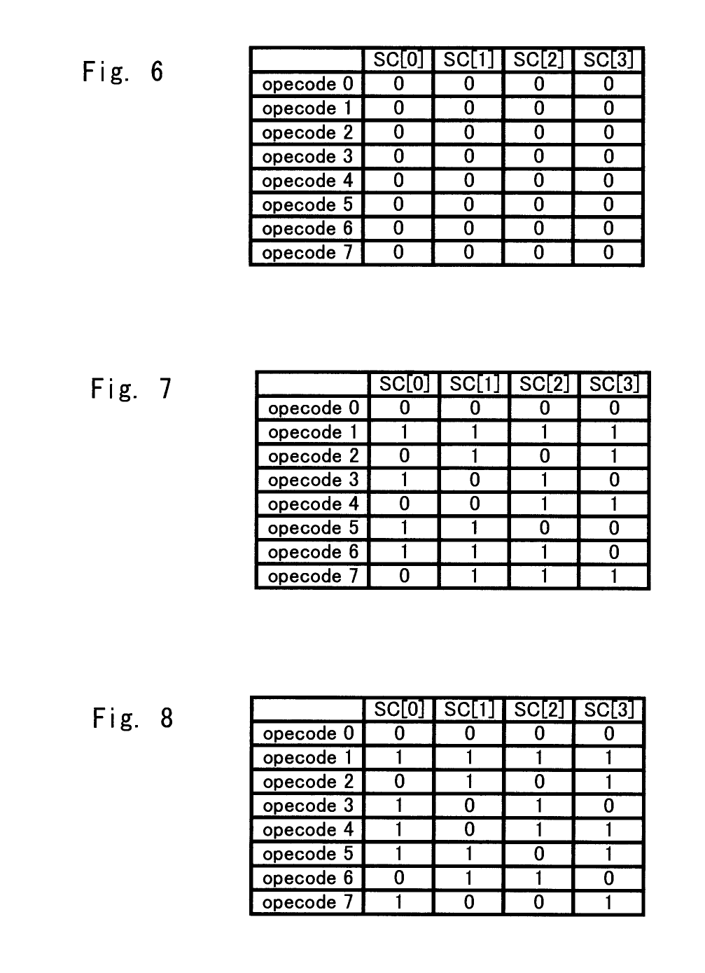

FIG. 6 to FIG. 8 are exemplary diagrams showing the operation code tables stored in the operation code table register 22. Note that the operation code tables described in FIG. 6 to FIG. 8 correspond to the eight operation codes. FIG. 6 is a diagram showing the state of the operation code table (i.e., the initial state of the operation code table) after the power-on reset signals become effective. As shown in FIG. 6, all of the values of the selection signals SC[0] to SC[3] are 0 at the initial state of the operation code table. Note that the all of the values of the selection signals SC[0] to SC[3] are not limited 0 at the initial state of the operation code table. That is, the values of the selection signals SC[0] to SC[3] can be determined as desired at the initial state of the operation code table.

FIG. 7 is a diagram showing the state of the operation code table when a first program is executed at the information processing unit 1.

FIG. 8 is a diagram showing the state of the operation code table when a second program is executed at the information processing unit 1. As shown in FIG. 7 and FIG. 8, in the SIMD arithmetic unit according to this exemplary embodiment, the values of the operation code tables are different with respect to each program that is executed at the information processing system 1. In the example shown in FIG. 7 and FIG. 8, the zeroth to third operation codes (opecode 0 to 3) of the first program are the same as those of the second program. On the other hand, the fourth to seventh operation codes (opecode 3 to 7) of the first program are different from those of the second program. That is, when the operation code numbers 4 to 7 are selected during a period of executing the second program, the decoder 21 in the SIMD arithmetic unit 10 outputs the select signal SC that has the different values compared with the values output during a period of executing the first program.

Note that, in the operation code table, the values of the selection signal can be fixed at the same values corresponding to a certain operation code instead of specifying all the values with respect to each program. For example, all the values of the selection signal can be 0 for the zeroth operation code regardless of the program, and all the values of the selection signal can be 1 for the first operation code regardless of the program. That is, in the operation code table according to this exemplary embodiment, a table area where the values of the selection signal are combined as desired with the use of the program is at least needed. In case of fixing the combination of the values of the selection signal corresponding to some operation codes, the values can be fixed by shorting to a power line or a ground line of the SIMD arithmetic unit 10 instead of using flip-flop circuits for the code setting value register. This configuration makes it possible to reduce a circuit size.

The data register 23 includes a plurality of data storage area specified by the register address. In this exemplary embodiment, a data width of one data storage area in the data register 23 is 32-bit.

The load-store unit 24 evacuates the setting value S2 that is stored in the operation code table register 22 and the data S3 that is stored in the data register 23 to the memory 12 or the like in accordance with a load-store control signal LSC that is output from the interrupt controller 25. Further, the load-store unit 24 reads out the setting value S2 and the data S3 that are stored in the memory 12 or the like and used for the following program. Moreover, the load-store unit 24 stores the setting value S2 and the data S3 in the operation code table register 22 and data register 23, respectively.

The interrupt controller 25 outputs an update signal UPD and the load-store control signal LSC when receiving the interrupt notification signal S0 output from the timer 13. The update signal UPD is the signal for directing the fetch unit 20 to switch the instruction streams which are read out from the memory 12. The load-store control signal LSC is the signal for directing the load-store unit 24 to switch the setting value S2 that is stored in the operation code table register 22 and the data S3 that is stored in the data register 23.

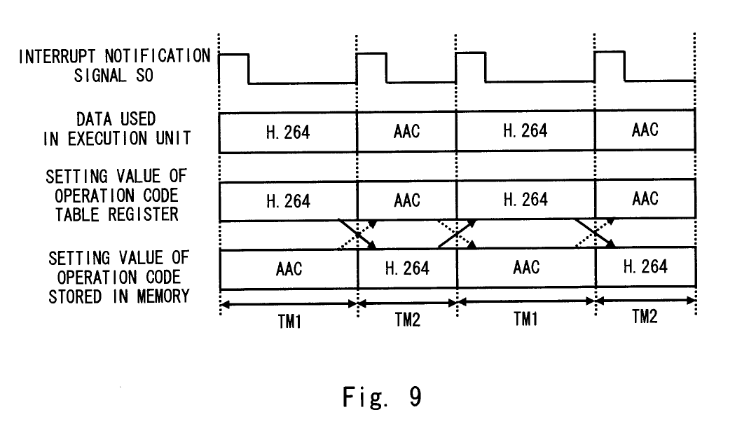

Hereinafter, an operation of the information processing system 1 is described. FIG. 9 is a timing chart showing the exemplary operation of the information processing system 1. In the example shown in FIG. 9, the information processing system 1 plays a movie with H.264 format. In the movie with H.264 format, a program for playing the moving image with H.264 format (e.g., the first program) that plays the moving image part of the movie and a program for playing the sound with AAC format (e.g., the second program) are executed. Further, while one processing unit of the program for playing the moving image is 8-bit data, one processing unit of the program for playing the sound is 32-bit data. Therefore, when executing the two programs with the SIMD arithmetic unit 10, the combination of the arithmetic operations in the execution unit is different between the two programs. In the example shown in FIG. 9, each of the program for playing the moving image and the program for playing the sound uses the different operation code table.

As shown in FIG. 9, during a first period TM1 when the program for playing the moving image is executed, the moving image data with H. 264 format is stored in the data register 23. Further, the operation code table corresponding to the program for playing the moving image is stored in the operation code table register 22. Further, the sound data with AAC format that is not in processing in the SIMD arithmetic unit 10 and the operation code table corresponding to the program for playing the sound are stored in the memory 12. During the first period TM1, the fetch unit 20 fetches the instruction stream specified by the program for playing the moving image. The decoder 21 decodes the operation instruction fetched by the fetch unit 20. Thus, the arithmetic operation for the image data with H.264 format is performed during the first period TM1.

On the other hand, during a second period TM2 when the program for playing the sound is executed, the sound data with AAC format is stored in the data register 23. Further, the operation code table corresponding to the program for playing the sound is stored in the operation code table register 22. Further, the moving image data with H. 264 format that is not in processing in the SIMD arithmetic unit 10 and the operation code table corresponding to the program for playing the moving image are stored in the memory 12. During the second period TM2, the fetch unit 20 fetches the instruction stream specified by the program for playing the sound. The decoder 21 decodes the operation instruction fetched by the fetch unit 20. Thus, the arithmetic operation for the sound data with ACC format is performed during the second period TM2.

In the example shown in FIG. 9, the program for playing the moving image and the program for playing the sound are executed with respect to each frame. Therefore, the timer 13 launches the interrupt notification signal S0 in every time when the data processing of one frame is concluded in SIMD arithmetic unit. The fetch unit 20 switches the instruction stream that is fetched in accordance with the launching of the interrupt notification signal S0. In addition, the load-store unit 24 replaces the setting value of the operation code table register 22 and the data of the data register 23 with the setting value and the data stored in the memory 12 in accordance with the launching of the interrupt notification signal S0.

As described above, in the information processing system 1 according to this exemplary embodiment, the decoder 21 changes the correspondence relationship between the operation instruction (i.e., operation code number in detail) and the values of the selection signal SC with respect to each program. Thus, the correspondence relationship necessary for each program between the operation instruction and the values of the selection signal SC is defined. Therefore, it is possible to take full advantage of the processing ability of the information processing system 1 even though the number of operation codes is limited.

Further, the correspondence relationship between the operation instruction such as the operation code table or the like and the values of the selection signal SC is set as desired with respect to each program in the information system 1. That is, the programmers can set as desired the correspondence relationship between the operation instruction and the values of the selection signal SC. Therefore, even if the combination of the values of the selection signal SC corresponding to the operation instruction that is necessary for the program is changed after completing the system design of the information system 1, it is possible to accommodate flexibly by only changing the program. Because there is no need to change the system design of the information system 1 according to this exemplary embodiment, it is possible to shorten the time for design of the information system 1 and the time for creating the program.

While the invention has been described in terms of several exemplary embodiments, those skilled in the art will recognize that the invention can be practiced with various modifications within the spirit and scope of the appended claims and the invention is not limited to the examples described above.

Further, the scope of the claims is not limited by the exemplary embodiments described above.

Furthermore, it is noted that, Applicant's intent is to encompass equivalents of all claim elements, even if amended later during prosecution.

The operation code table register 22 may be implemented separately from the SIMD arithmetic unit 10.

Further, there is no need for storing the setting value in the memory 12. A part of the values stored in the data register 23 may be used as the setting value that is stored in the operation code table register 22. Values read from a storage device outside of the information system 1 may be used as the setting value that is stored in the operation code table register 22.

What is claimed is:

1. An information processing system that executes an information processing corresponding to a program comprising:
an execution unit that includes a plurality of arithmetic units each having a first operation circuit that performs a first operation on a first input value and a second input value, a second operation circuit that performs a second operation on the first input value and the second input value, and a selector that selects and outputs either a first output value output from the first operation circuit or a second output value output from the second operation circuit based on a selection signal; and
a decoder that decodes an operation instruction and determines each value of the selection signal of each arithmetic unit;
wherein the decoder determines the value of the selection signal corresponding to the operation instruction with respect to each program.

2. The information processing system according to claim 1, further comprising an operation code table that stores the value of the selection signal corresponding to the operation instruction,
wherein the value of the selection signal corresponding to the operation instruction that is stored in the operation code table is rewritable with respect to each program.

3. The information processing system according to claim 2, wherein a number of the operation instructions that are defined by the operation code table is less than a number of combinations of the first operation circuits and the second operation circuits of the plurality of arithmetic units.

4. The information processing system according to claim 2, wherein the operation code table has an area in which the value of the selection signal corresponding to the predetermined operation instruction is preliminarily fixed.

5. The information processing system according to claim 3, wherein the operation code table has an area in which the value of the selection signal corresponding to the predetermined operation instruction is preliminarily fixed.

6. The information processing system according to claim 1, wherein the value of the selection signal corresponding to the operation instruction is specified by the program, and the decoder decodes the operation instruction based on the value of the specified selection signal during a period of executing the program.

7. The information processing system according to claim 1, further comprising a data register that stores the first input value, the second input value, and the output value output from the selector,
wherein the decoder decodes the operation instruction and outputs addresses of the data register in which the first input value, the second input value, and the output value are stored.

8. The information processing system according to claim 1, further comprising a timer that times an execute time of the program and directs the decoder to switch the value of the selection signal corresponding to the operation instruction in accordance with the execute time.

9. An information processing system comprising:
an operation code table register that stores values each corresponding to respective operation code;
a decoder that is coupled to the operation code table register to output an select signal in accordance with the values that is stored in the operation code table register;
an execution unit that includes a first operation circuit configured to perform a first operation based on a first value and a second value, a second operation circuit configured to perform a second operation based on the first value and the second value, and a selector that is coupled to the first and second operation circuits to select one of results of the first operation and the second operation in accordance with the select signal; and
a load-store unit that is coupled to the operation code table register to change the values to another values in accordance with an operation to be executed by the information processing system.

10. An information processing method for use in an information processing system that includes a plurality of arithmetic units each having a first operation circuit that performs a first operation on a first input value and a second input value, a second operation circuit that performs a second operation on the first input value and the second input value, and a selector that selects and outputs either a first output value output from the first operation circuit or a second output value output from the second operation circuit based on a selection signal, and executes an information processing corresponding to a program, the method comprising:
determining a value of the selection signal corresponding to an operation instruction in accordance with the program;
decoding the operation instruction in accordance with the determination and generating the select signal; and
determining the output value that is output from the selector in the plurality of arithmetic units based on the value of the selection signal.
